(19) United States
(12) Patent Application Publication
(10) Pub. No.: US 2005/0256694 A1
(43) Pub. Date: Nov. 17, 2005

(54) Variable accuracy simulation software and method of using the same

(76) Inventor: Mike Taylor, Marietta, GA (US)

Correspondence Address: MCKENNA LONG & ALDRIDGE LLP, 1900 K STREET, NW, WASHINGTON, DC, 20006, US

(21) Appl. No.: 10/843,695

(22) Filed: May 12, 2004

(51) Int. Cl. G06F 9/45

(52) U.S. Cl. 703/22

(57) ABSTRACT

Variable accuracy simulation software for modeling an existing or planned wireless network includes a modeling framework containing a of predetermined software objects configured to model a network elements of the existing or planned wireless network. The simulation software enables the generation of at least one process related to at least one of the software objects, wherein the at least one virtual process corresponds to a physical process related to the existing or planned wireless communications network. The simulation software also includes accuracy adjusting means for selectively adjusting the accuracy and execution speed of an output generated upon the interaction of the at least one software object and the at least one virtual process. The simulation software also enables modeling network user behavior and cost-based analysis of the wireless network.

### BACKGROUND OF THE INVENTION

1. Field of the Invention

The present invention relates to a software product capable of being integrated into software applications. More particularly the present invention relates to a software product capable of modeling the behavior and performance of large scale, complex wireless communications networks in a timely manner.

2. Discussion of the Related Art

Network simulation has been a very important “tool” in the design and the prediction of the performance of communications networks. During the design phase, system simulation provides the means to study design tradeoffs and identify performance bottlenecks—thereby shaping the architecture and top-level design of the communications network. During the post-design time frame, simulation serves to tune system performance through optimization of system configuration parameters and to identify potential design improvements. It, also, serves to generate performance predictions for new system applications prior to their implementation. The need for network simulation becomes imperative for large, complex networks where the risks of designing the “wrong” network become enormous. Large-scale communications networks represent such complex systems and are today, one of the major applications of simulation. At the same time, the emergence of inexpensive computing power makes system simulations affordable.

Simulations can be classified into three types: continuous time, discrete time, and discrete event. The specific type of simulation described herein within the context of the present invention is known as discrete event simulation (DES). That is, simulations where system state changes occur, in response to applied stimuli, at certain points in time. Real world systems modeled using DES are decomposed into a set of logically separate processes autonomously progressing through time. Each event occurs on a specific process. The result of events can include messages passed to one or more processes (including, if required, the process on which the event occurred). On arrival at this other process, the content of the message may result in the generation of new events, to be processed instantaneously or at some specified future time.

Many DES software programs that model communication networks at the system level are built upon a framework of link-level modeling (i.e., the conceptual level of control that controls the data-link). Link-level modeling typically determines the state of each frame (i.e., a sequence of contiguous bits or digits transmitted as a unit) transmitted via an RF signal as received by one or more receivers. Link-level based system simulators are intrinsically limited in their ability to model system level processes at varying and configurable levels of abstraction. Frame rates (i.e., the number of frames transmitted or received per unit time, usually expressed as frames per second) in digital communications systems tend to be very large. The exact frame rate is dependant on the air interface standard of a wireless network (i.e., IS-95, GSM, IS-136). Transmitted signals are passed through the model of the RF propagation environment. The RF propagation environment produces multi-path signals. Causes of multi-path signals include atmospheric ducting, ionospheric reflection, and refraction, and reflection from terrestrial objects (e.g., mountains buildings, etc.). Each multi-path signal independently experiences loss in power as well as time delay. The multi-path signals also experience constructive and destructive interference within the receiver depending on their relative delays. The resultant RF signal is then demodulated and error rates are determined. Error rates are probabilistic and are a function of the air interface standard, RF Propagation characteristics, signal quality, and velocity of the transmitters and receivers. This basic link-level simulation is then used as a foundation for modeling the behavior and performance of a network and must model every frame at the link-level, for all network users.

Link-level based simulation schemes generally require computational power much greater than is readily available to a number of potential end users. Further, system level modeling of communications systems that are link-level based often take hours or days to produce just one set of results. Accordingly link-level based simulations can be both economically and operationally unviable for analysis of wireless systems with a large number of users. Several wireless network infrastructure equipment vendors, however, have created various software programs which utilize simulation techniques to model system level behavior.

A network simulation product known as OPNET is a commercially available software product that uses DES techniques to model wireless communications networks. OPNET was originally written to simulate wired networks (e.g., LANs and WANs) and was later expanded to model wireless networks. OPNET is based upon link-level simulation. As a consequence, OPNET is inherently limited in it's ability to model large wireless networks and network users in a timely manner. Because of these limitations, end users of simulation software such as OPNET are typically R&D engineers who develop new network elements (i.e., telecommunications equipment providing support or services to a network user) or network level control algorithms. Further, simulation software such as OPNET are not structured such that their simulation capability can be easily integrated into host applications. Rather, software products such as OPNET are intended to be used as stand-alone applications.

Another network simulation software known as Block Oriented Network Simulator (BONES) includes simulation packages allowing a user to access software language optimized for simulation of networks. Here, users are required to specify the internal workings of a network by defining message types, algorithms, protocols, etc. Users then create their own process models for vendor specific equipment and for many of the system level processes. Such work is normally conducted by highly trained R&D engineers.

Existing software simulating wireless networks employ techniques and methods that have the following drawbacks: simulation functionality is specific to a required application; software runs prohibitively slow for using simulation results to make operational decisions about the network; simulation is specific to a particular air interface; simulation is specific to a particular user/manufacturer of equipment; and modeling of all network elements and processes is carried out at the same level of abstraction (the level of abstraction, in essence, is hard coded into the simulation software).

### SUMMARY OF THE INVENTION

Accordingly, the present invention is directed to wireless network simulation software that substantially obviates one or more of the problems due to limitations and disadvantages of the related art.

An advantage of the present invention provides simulation software where a user specifies only hardware and software parameters of a network, as well as characteristics of the users that utilize the network, to run a simulation.

Another advantage of the present invention provides a generic simulation based software library capable of modeling substantially all types of wireless networks and dynamic, time dependent processes, and their effects.

Still another advantage of the present invention provides improved execution speed of simulations of wireless networks having large numbers of users.

Yet another advantage of the present invention allows end users to model wireless networks and recognize tradeoffs between performance and cost in existing or proposed networks.

A further advantage of the present invention enables the modeling of interactions between different types of networks (e.g., networks having the same air interface type but using network equipment from different vendors; networks having different air-interface types, etc.).

An additional advantage of the present invention provides simulation software that facilitates simulation based software products to be designed and implemented with minimal knowledge of underlying network protocols, standards, messaging, algorithms, and control processes.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of simulating a physical system with variable accuracy may, for example, include providing at least one virtual system element configured to model a corresponding physical system element of a physical system; and generating at least one virtual process related to the at least one virtual system element, wherein the at least one virtual process corresponds to a physical process related to the corresponding physical system element, wherein the generation is based on at least one alterable characteristic of at least one virtual process.

In another aspect of the present invention, a variable accuracy simulation software may, for example, include a modeling framework containing at least one virtual system element configured to model a corresponding physical system element of a physical system; at least one virtual process related to the at least one virtual system element, wherein the at least one virtual process corresponds to a physical process related to the corresponding physical system element; and accuracy adjusting means for adjusting the accuracy of an output generated upon the interaction of the at least one virtual system element and the at least one virtual process.

It is to be understood that both the foregoing general description and the following detailed description are exemplary and explanatory and are intended to provide further explanation of the invention as claimed.

### DETAILED DESCRIPTION OF THE ILLUSTRATED EMBODIMENTS

Reference will now be made in detail to embodiments of the present invention.

According to the principles of the present invention, discrete event simulation (DES), discrete time simulation (DTS). and object orient programming (OOP) techniques may be used as the basis for providing simulation software capable of efficiently modeling the behavior and performance of large scale, complex systems such as wireless communications networks.

In one aspect of the present invention, the simulation software may comprise a modeling framework used by end user software products (i.e., host applications) that require modeling and analysis of the behavior and performance existing or planned wireless communication networks and their users (i.e., physical wireless networks).

In one aspect of the present invention, the modeling framework may comprise a hierarchical library of a plurality of predetermined software objects. Each of the plurality of software objects may be individually configured by the host application to model the attributes and behavior of network elements included within a physical wireless network (i.e., physical network elements). Accordingly, virtual network elements may comprise one or more software objects configured to model the attributes and behavior of a corresponding physical network element. Physical network elements may be characterized as any physical or theoretical entity included within a physical wireless network. Accordingly, physical network elements may, for example, include mobile switching centers (MSCs), base station controllers (BSCs), cells, sectors, base stations, radio frequency (RF) signals, RF feed lines, antennas, RF Signal propagation environment, network users, terminal units using the network (e.g., cellular phones, radio device, etc), and the like.

In one aspect of the present invention, each virtual network element may comprise a plurality of virtual subsystem elements comprising attributes configured to model subsystems in corresponding physical network elements (i.e., physical subsystem elements). Accordingly, the virtual subsystem elements may also include the aforementioned software objects that wholly represent singular virtual network elements. Virtual subsystem elements may be re-used within a single virtual network element or may be re-used within separate virtual network elements. Further, the separate virtual network elements comprising the re-used virtual subsystem elements may be identical or different. For example, attributes of one virtual subsystem element may be configured to model the behavior of a subsystem (e.g., an antenna) in a physical network element (e.g., a base station, a terminal unit, etc.).

In one aspect of the present invention, the behavior of each virtual network element may be configured to model the behavior of a corresponding physical network element. In another aspect of the present invention, characteristics describing relationship(s) between virtual network elements may be configured to model the relationship(s) between corresponding physical network elements.

In another aspect of the present invention, processes determining the overall behavior of the virtual wireless network may be configured to model the behavior of a corresponding physical wireless network to a desired level of abstraction. For example, processes such as establishing a call on the wireless network, handover from one cell area to another cell area, power control of a terminal unit, power control of a base station, and the like, may be modeled within the simulation software such that the overall behavior of the virtual wireless network is determined by substantially the same processes as the physical wireless network. Therefore, the overall behavior and performance of the virtual wireless network may be configured to model a corresponding physical wireless network.

In the present aspect of the invention, processes may be contained entirely within individual virtual network elements (e.g., a process within a terminal unit for determining a frame error rate (FER)). Further, processes may be distributed between virtual network elements. Processes modeled by the simulation software of the present invention may be implemented almost instantaneously or may be implemented over a period of time.

By modeling the behavior and processes of individual virtual network elements in addition to relationships and processes between virtual network elements, the simulation software of the present invention may model a plurality of virtual network elements to behave and interact in substantially identical ways as corresponding physical network elements interact with each other. The virtual wireless network, comprising the community of individually configured virtual network elements, may model the behavior and performance of a corresponding physical wireless network.

In one aspect of the present invention, the host application may create a virtual wireless network within the simulation software. In another aspect of the present invention, the virtual network may be configured by the host application to model an entire physical wireless network or only portions of the physical wireless network. For example, the host application may configure a plurality of virtual network elements comprising software objects configured to model network users. Accordingly, a virtual wireless network may be created that is designed to model the behavior of network elements including network users that place calls on a physical wireless network.

Once the virtual wireless network is created, the host application may use the simulation software to model a physical wireless network. In one aspect of the present invention, behavior and performance data from each software object may be available to the host application. Accordingly, the host application may access all parametric, performance, and state data for each of the virtual network elements and virtual subsystem elements, all data related to the relationships between the virtual network elements and virtual subsystem elements, and all data related to the virtual processes for display and analysis purposes. The host application can also configure the virtual wireless network, place users onto the virtual wireless network, access all virtual data generated from the virtual wireless network, display all data from the virtual wireless network in a format (e.g., charts, maps, graphs, tables, etc.) required by the end user, etc. In one aspect of the present invention, the host application may interface the simulation software via a bi-directional interface.

As mentioned above, the modeling framework may comprise a plurality of the software objects. In one aspect of the present invention, the plurality of software objects contained within the modeling framework are grouped according to a predetermined hierarchy of object levels. Accordingly, the modeling framework may comprise three object framework levels: (1) a network simulation object level; (2) an air interface object level; and (3) a vendor object level.

The network simulation object level may contain software objects that generically form the basis of virtual network and subsystem elements used in modeling physical network elements and their subsystems in substantially all species of physical wireless networks. Accordingly, software objects contained within the network simulation object level are generic to all wireless communications systems. Software objects contained within the network simulation object level are not contained in either of the air interface object or the vendor object levels but may be used as the bases for which objects found in those object levels are formed. In one aspect of the present invention, software objects contained within the wireless network simulation framework level may, for example, include software objects configured to resemble antennas, RF propagation paths, RF feed lines, RF combiners and splitters, RF signals, Mobile Switching Centers (MSC), Base Station Controllers (BSC), Channel Elements, etc.

The air interface object level may contain software objects related to various air interface standards (e.g., IS-95 CDMA, 1XRTT CDMA, IS-136 TDMA, GSM, UMTS, Wireless LAN, etc.). In one aspect of the present invention, software objects contained within the air interface specific level may, for example, include software objects defined by attributes configured to model uplink and downlink RF signals containing encoded information such as air interface specific messages, base stations, cells, sectors, etc. According to the principles of the present invention, many processes within, and distributed between, the virtual network elements are specific to a particular air interface type. Accordingly, software objects contained within the air interface object level may be configured to include processes according to a predetermined air interface standard (e.g., handover from one cell to another, call establishment, power control, etc.).

The vendor object level may contain software objects related to hardware and software produced by wireless network and terminal unit equipment vendors. In one aspect of the present invention, software objects contained within the vendor object level may for example, include software objects configured to include processes and control algorithms that are specific to a predetermined vendor. In another aspect of the present invention, software objects found within the vendor object level are not found within the air interface object level.

In accordance with the principles of the present invention, the modeling framework may enable a plurality of unique physical wireless networks to be concurrently modeled. For example, if the network of a first personal communications system (PCS) operator is geographically adjacent a network of a second PCS operator, both physical networks may be concurrently modeled using the objects in the modeling framework. Using, for example, the aforementioned model of adjacent networks, the processes occurring between networks (i.e., handover) may be modeled to a desired level of abstraction.

In another aspect of the present invention, the modeling framework may enable concurrent modeling of physical wireless networks having diverse air interface standards. For example, multiple virtual wireless networks may be created using the simulation software wherein some or all of the virtual wireless networks operates according to a different air interface standard (e.g., one virtual wireless network uses GSM while another virtual wireless network uses IS-95). Accordingly, the simulation software may, for example, model interference from transmitters from one wireless network upon receivers of another wireless network and mitigate any effects of such interference.

In still another aspect of the present invention, the modeling framework enables the modeling of virtual network and subsystem elements of used/manufactured by particular vendors. Accordingly, the performance and behavior of equipment used and/or manufactured by various vendors may be modeled. Therefore, the simulation software of the present invention may model how different algorithms of different vendors trigger processes defined a particular air interface specification.

In one aspect of the present invention, the simulation software may comprise an accuracy varying means. Conceptually, the accuracy varying means may control a level of abstraction for processes relating to the virtual wireless network and may be distributed throughout the simulation software. In one aspect of the present invention, the accuracy varying means may be configured by a user before a particular simulation is run. Via the accuracy varying means, processes relating to the virtual wireless network may all be modeled to a desired level of abstraction. Contrary to related art network simulators such as those described in the preceding section, the simulation software of the present invention does not model network elements, subsystems, processes, etc., solely at a single level of abstraction (e.g., the link-level). Rather, processes may be modeled at a desired level of abstraction. Accordingly, the accuracy with which a virtual wireless network generated by the simulation software models a corresponding physical wireless network, and the speed at which the simulation software executes processes, may be made variable. According to the principles of the present invention, the level of detail (i.e., abstraction) used in configuring virtual network elements and/or virtual subsystem elements within a virtual wireless network to model their counterpart physical elements and/or processes may be made as high as, or as low as, the end user requires. This enables the user of the simulation software to control the tradeoff between execution speed of the simulation and accuracy of the simulation results.

According to principles of the present invention, the level of abstraction at which a virtual wireless network is modeled may be made as high as possible (e.g., with a minimum amount of detail) as long as the essential characteristics and behaviors of the virtual wireless network is preserved for the purpose of the simulation. Virtual wireless networks modeled at lower levels of abstraction (e.g., the link level) generally model corresponding physical wireless networks at a greater accuracy relative to virtual wireless networks generated at higher levels of abstraction. On the other hand, virtual wireless networks modeled at higher levels of abstraction (e.g., conceptual levels of control or processing logic that are above the link-level and control link-level functions (e.g., device control, buffer allocation, and station management)) generally model corresponding physical wireless networks at a greater execution speed relative to virtual wireless networks generated at lower levels of abstraction.

In one aspect of the present invention, the level of abstraction for specific process models involving one or more virtual network or subsystem element may be variable. Again, the minimum or maximum levels of abstraction implemented may be determined taking into account the requirements of the simulation and the capabilities of the hardware supporting the simulation software. Accordingly, tradeoff between execution speed of the simulation and accuracy of the simulation results may be controlled.

In another aspect of the present invention, processes (e.g., forward power control) may be re-used and modeled at different levels of abstraction for different instances of the same software object. Additionally, levels of abstraction of processes may be individually configurable on a process-by-process basis.

As mentioned above, processes distributed between virtual network elements often have a large influence on the behavior and performance of the network because, at least in part, outputs of some processes (i.e., sub-processes) may serve as the inputs of other processes. Accordingly, optimizing the speed at which even one a sub-process is executed may result in a large optimization of time required to execute the simulation. Accordingly, levels of abstraction for sub-processes may be automatically based on the level of abstraction for down-stream processes using outputs of the sub-processes.

For example, a particular Terminal Unit may periodically model, for example, a power control process at a high level of abstraction. In some cases, the power control process may be initiated by different upstream process(es) that require modeling of the power control for that specific terminal unit at a lower level of abstraction. The upstream process can initiate this process model at the level of abstraction required for that process.

If a forward power control process is modeled at a low level of abstraction (e.g., link or frame level), then a required signal strength measurement process is modeled, at least in part, at the low level of abstraction. Conversely, if the forward power control process is modeled at a relatively higher level of abstraction, (e.g., a statistical level at a rate of one sample per second), then the required signal strength measurement process can be modeled, at least in part, at the relatively higher level of abstraction.

In another example, the forward power control process in an IS-95 system may be modeled at a high level of abstraction by statistically characterizing transmitted power over a period of time, wherein the transmitted power may be set to the mean power level over the predetermined period of time. At a much lower level of abstraction however, the aforementioned forward power control process may be modeled specifically as defined by the IS-95 system. Accordingly, modeling at the lower level of abstraction requires that the transmitted power be controlled in every frame. Therefore, while modeling at the lower level of abstraction may be more accurate, modeling the forward power control process at the higher level of abstraction may result in a reduction of process execution times of several orders in magnitude.

In another example, within power control processes for physical IS-95 Terminal Units, transmitted power is adjusted at an interval (e.g., 1.25 milliseconds) determined by corresponding Power Control Groups. Accordingly, a relatively low level of abstraction may be used to model a virtual power control process every 1.25 milliseconds in a manner substantially identical to the physical power control process. By modeling the power control process at the low level of abstraction, the transmit power of the Terminal Unit may track a rapid fading of an RF path between a Terminal Unit and a Base Station. By tracking the strength of the RF path, the average power of the Terminal Unit can be modeled by calculating a rolling average of transmitted power over a succession of power control groups. As can be seen from the discussion above, modeling the power control process at a low level of abstraction allows parameters that affect the power control process between a Terminal Unit and Base Stations for every control group to be individually adjusted and analyzed. Alternatively, a higher level of abstraction may be used to model a power control process only at the average transmit power of the Terminal Unit. In this case, the average transmit power of the Terminal Unit may be determined algorithmically and initiated by an upstream process as required.

In still another example, a Terminal Unit Access Probe process for setting up a call on an IS-95 system may be modeled at a low level of abstraction that closely follows physical processes set forth in the IS-95 specification. Accordingly, a series of successive access probes are sent by the Terminal Unit to a Base Station, wherein each sequence of access probes within the series is transmitted at increasing power levels until the Terminal Unit signal is received by the Base Station or until the Terminal Unit transmits its last access probe and the Base Station fails to receive the transmitted access probe. Accordingly, the Terminal Unit transmits a predetermined number of sequences of access probe within the series. If the Base Station fails to receive any of the transmitted access probes, the call setup will fail. Modeled at a higher level of abstraction, however, the Terminal Unit Access Probe process may transmit one access probe at the highest power level of all access probes within the aforementioned sequence of access probes. In view of the example above, only one virtual access probe is sent using the higher level of abstraction, resulting in less computation. Using the higher level abstraction, the modeled Terminal Unit Access Probe process may determine if a Terminal Unit successfully set up a call but may not determine whether the actual access probe was successfully received. Accordingly, it may not be desirable to model the Terminal Unit Access Probe process at the higher level of abstraction if the goal of the simulation is to optimize the access probe parameters.

Some host applications using the simulation software of the present invention may require the accuracy offered by lower levels of abstraction while other host applications may require the increased execution speed offered by higher levels of abstraction. Accordingly, the accuracy adjusting means within the simulation software of the present invention enables end users to optimize the performance of the virtual wireless network based on the particular requirements of the intended host application.

In one aspect of the present invention, the accuracy varying means may conceptually comprise an analysis interval module. The analysis interval module may be used to alter the intervals of time during which the simulation software invokes process models within the software. During simulation, processes in physical wireless networks may modeled at regular intervals, wherein the regular intervals may or may not be explicitly required or defined. In cases where the processes of physical wireless networks are implemented irregular intervals, modeling of the processes at a low level of abstraction results in modeled processes that are also not repetitive in nature. However, if network processes that occur at irregular intervals are modeled at higher levels of abstraction, the process model may end up being invoked on a periodic basis.

For example, if the aforementioned forward power control process is modeled at a low level of abstraction, the analysis interval corresponds to the power control group period. Accordingly, the transmitted power must be analyzed during each power control group period. Thus, when the process is modeled at the low level of abstraction, an analysis interval becomes very specific and cannot be altered. However, if the forward power control process is modeled at a high level of abstraction, the analysis interval corresponds to a certain amount of time. Accordingly, the transmitted power may be analyzed statistically over the period of time. In one aspect of the present invention, the amount of time over which the transmitted power is statistically characterized may not explicitly defined by the method modeling the forward power control process.

In view of the above, the principles of the present invention provide a configurable analysis interval for modeled processes as long as the modeled process does not require a specific analysis interval. Accordingly, a tradeoff in modeling individual processes may be provided, wherein smaller analysis intervals yield increased accuracy and wherein larger analysis intervals yield increased execution speed.

Some host applications may require greater accuracy from certain process models than others. Accordingly, the present invention allows analysis intervals to be configured on an application by application basis, as well as for specific process instances within a given simulation. For process models having configurable analysis intervals, analysis intervals may be set to an optimized amount of time required to achieve the desired accuracy level at acceptable simulation execution speeds.

In one aspect of the present invention, analysis intervals may be set prior to execution of the modeled processes when the host application configures a virtual wireless network via the simulation software. Analysis intervals may also be changed on-the-fly within the simulation as required (e.g., as a result of a change of state that contains the modeled process).

For example, virtual network elements representing network users may be placed within the virtual wireless network for different purposes. For example, a class of virtual network users may be characterized as “static users”, which are configured model all processes initiated by users (e.g., place calls, receive calls, power control, etc.) that do not change their geographic locations. Accordingly, a large number (e.g.,. thousands, tens of thousands, etc.) of static users may be modeled within the virtual network to load the network. In one aspect of the present invention, processes initiated by static users may be modeled at high levels of abstraction sufficiently accurate to model terminal unit processes. Accordingly, processes initiated by static users may be modeled at an analysis interval of about 60 seconds. A second class of virtual network users may be characterized as “probe users”, which are configured model all processes initiated by the static users but do change their geographic locations. Accordingly, a limited number (e.g., tens, hundreds, etc.) of probe users may be placed geographically in areas where problems are expected. In this case, processes initiated by probe users may be modeled at low levels of abstraction sufficiently accurate to model probe user's overall behavior in the network at significantly shorter analysis intervals. For example, an analysis interval of about one second may be sufficient to model the terminal unit process ‘in call’ for the probe users. By selectively adjusting the analysis intervals of modeled processes, the simulation software may reduce the overall execution time of the simulation by several orders of magnitude without significantly affecting the accuracy of the results. Furthermore, the analysis interval for each static user may vary based on its geographic proximity to the probe user(s).

As mentioned above, some of the virtual network elements may comprise software objects configured to model the behavior of real or potential users of a physical wireless network. Accordingly, a plurality of virtual network user types may be defined (e.g., business user, student, data user, probe, static, etc.) wherein each virtual network user may be described as having different movement patterns, usage patterns, sensitivity to network quality, etc.

One aspect of the user behavior may be based on the quality of service obtained from the network. For example, virtual network users may decide if they will discontinue service with their current wireless network and move to another network (a behavior known as ‘churning’). Metrics capable of determining user satisfaction include, but are not limited to, the percentage of calls that drop, the percentage of time call quality falls below an acceptable threshold, call setup success rate, cost of service, etc. The sensitivity of each user type to network quality may be defined statistically. For example, if two different virtual network users experience the same level of satisfaction, one may decide to churn while the other may choose to remain on the current network.

In appreciation of the fact that nearly all decisions made in designing, optimizing, and operating a wireless network, etc., are business decisions, the present invention enables cost modeling of physical wireless networks. For example, a new cell site may have a capital cost of $1,000,000 and an annual operating cost of $100,000. In return, the network operator can expect increased capacity and therefore usage in the area of the new cell site. If the new cell site results in improved quality of service, the operator may retain more customers or be able to charge more for service. In accordance with the principles of the present invention, attributes such as capital costs and operating expenses may be assigned to each virtual network or subsystem element. These costs can then be analyzed and compared with relative benefits gained from the changes.

In accordance with the principles of the present invention, the simulation software may be used by host applications requiring functionality for modeling dynamic behavior, processes, and performance of wireless communications networks. The simulation software of the present invention facilitates the modeling of system level processes, behaviors, and performance of physical wireless networks of any size. Further, the simulation software of the present invention may be implemented on commonly available computing platforms (e.g., standard laptop and desktop PCs) and produce results within a time frame such that engineering, operational, and administrative decisions with regard to design and operation of wireless communications networks can be made based on results of the simulation.

The simulation software may be provided as a drop-in component for any host application requiring accurate modeling of wireless networks. In one aspect of the present invention, the simulation software may be used like substantially any other software component, such as a Button, a Checkbox, etc., on a window.

Further, the simulation software may model a physical wireless network using only hardware and software parameters inputted by a user. By removing the related art simulator requirements of defining messages, constructing process models, etc., the present invention enables users (e.g., application engineers, software engineers, etc.) to integrate simulation based network analysis into host applications without having to be experts in the details of network protocol.

Still further, the above described simulation software may by used by end users of host applications that require modeling and analysis of behavior and performance of physical wireless networks. Accordingly, the simulation software of the present invention may be used to: make decisions about wireless network construction and expansion (e.g., determine where the best location to add a new cell, etc.); optimize software parameter settings of existing networks; optimize networks prior to their actual construction; determine root causes of specific network problems (e.g., dropped calls, etc.); determine geographic locations where network users experience problems; predict network performance under various network loading and usage scenarios; analyze new network equipment control algorithms; analyze benefits and risks for new types of physical network elements (e.g., smart antennas, etc.); predict capital and operating expenses; compare network performance based on vendor specific equipment functionality; determine relative resources required to support different types of network traffic (e.g., voice, data, etc.); optimize networks automatically; and so on.

It is to be understood that the principles of the present invention are not limited to the simulation of physical wireless communications networks but may also be applied to wired communications networks, traffic flow analysis, or to the simulation of any other assembly of resources and procedures united and regulated by interaction or interdependence.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of simulating a physical system with variable accuracy, comprising:
providing at least one virtual system element configured to model a corresponding physical system element of a physical system; and
invoking at least one virtual process related to the at least one virtual system element, wherein the at least one virtual process corresponds to a physical process related to the corresponding physical system element, wherein the invoking is based on at least one abstractable characteristic of the at least one virtual process.

2. The method of simulating a physical system with variable accuracy according to claim 1, wherein the invoking comprises invoking at least one virtual process within at least one of the at least one virtual system element.

3. The method of simulating a physical system with variable accuracy according to claim 1, further comprising:
providing at least two virtual system elements configured to resemble corresponding physical system elements of a physical system,
wherein the invoking comprises invoking at least one virtual process between at least two of the virtual system elements.

4. The method of simulating a physical system with variable accuracy according to claim 1, wherein the at least one alterable characteristic comprises a conceptual level of the physical system.

5. The method of simulating a physical system with variable accuracy according to claim 1, wherein the at least one alterable characteristic comprises an analysis interval applied to the physical system.

6. The method of simulating a physical system with variable accuracy according to claim 1, wherein the invoking comprises invoking at least one virtual process at a link-level of the physical system.

7. The method of simulating a physical system with variable accuracy according to claim 1, wherein the invoking comprises invoking at least one virtual process at levels above a link-level of the physical system.

8. The method of simulating a physical system with variable accuracy according to claim 1, wherein the invoking comprises invoking at least one virtual process based on an analysis interval applied to the physical system, wherein the analysis interval corresponds to a frame rate.

9. The method of simulating a physical system with variable accuracy according to claim 1, wherein the invoking comprises invoking at least one virtual process based on an analysis interval applied to the physical system, wherein the analysis interval corresponds to a statistical sampling period.

10. The method of simulating a physical system with variable accuracy according to claim 1, wherein the physical system comprises a network.

11. The method of simulating a physical system with variable accuracy according to claim 10, wherein the physical system comprises a wireless network.

12. The method of simulating a physical system with variable accuracy according to claim 10, further comprising modeling network user behavior.

13. The method of simulating a physical system with variable accuracy according to claim 12, further comprising modeling network user behavior of a geographically static user.

14. The method of simulating a physical system with variable accuracy according to claim 12, further comprising modeling network user behavior of a geographically mobile user.

15. The method of simulating a physical system with variable accuracy according to claim 10, further comprising modeling network cost.

16. Variable accuracy simulation software, comprising:
a modeling framework containing at least one virtual system element configured to model a corresponding physical system element of a physical system;
at least one virtual process related to the at least one virtual system element, wherein the at least one virtual process corresponds to a physical process related to the corresponding physical system element; and
accuracy adjusting means for adjusting the accuracy of an output generated upon the interaction of the at least one virtual system element and the at least one virtual process.

17. The variable accuracy simulation software according to claim 16, wherein
the at least one virtual system element comprises a plurality of virtual system elements; and
the modeling framework comprises a hierarchical library of the plurality of virtual system elements.

18. The variable accuracy simulation software according to claim 17, wherein the modeling framework comprises a first hierarchical level, the first hierarchical level comprising virtual system elements generic to a plurality of species of the physical system.

19. The variable accuracy simulation software according to claim 17, wherein the modeling framework comprises a second hierarchical level, the second hierarchical level comprising virtual system elements related to standard operating systems of a plurality of species of the physical system.

20. The variable accuracy simulation software according to claim 17, wherein the modeling framework comprises a third hierarchical level, the third hierarchical level comprising virtual system elements related to predetermined hardware of the physical system.

21. The variable accuracy simulation software according to claim 16, wherein the accuracy adjusting means alters a conceptual level of the physical system at which at least one virtual process models.

22. The variable accuracy simulation software according to claim 16, wherein the accuracy adjusting means comprises an analysis interval module for altering an interval of time during which the software analyses the physical system.

23. The variable accuracy simulation software according to claim 16, wherein the physical system comprises a wireless network.
